(19) United States
(12) Patent Application Publication
(10) Pub. No.: US 2004/0265091 A1
(43) Pub. Date: Dec. 30, 2004

(54) Universal bulkhead fitting

(76) Inventor: Kwun-Wing W. Cheung, Shoreline, WA (US)

Correspondence Address: Mark L. Lorbiecki, Esq., BLACKLOWE & GRAHAM PLLC, 816 Second Avenue, Seattle, WA, 98104, US

(21) Appl. No.: 10/609,870

(22) Filed: Jun. 30, 2003

(51) Int. Cl. F16B 21/00

(52) U.S. Cl. 411/338

(57) ABSTRACT

A flanged cylinder assembly includes a cylindrical housing having an axis and defining a bore along the axis. A spirally threaded groove is defined within the bore. The groove is spirally situated about the bore. The groove is arranged to engage a threaded land on a shaft of a fastener to secure the fastener in the bore. A flange is fixedly attached to the cylindrical housing perpendicular to the axis.

### RELATED APPLICATIONS

This invention is related to application Ser. No. 10/137,816 filed May 1, 2002, titled UNIVERSAL BASSINET FITTINGS, Attorney Docket number BOEI-1-1059. This reference incorporates that application.

### FIELD OF THE INVENTION

This invention relates generally to fittings and, more specifically to fittings for fastening to bulkhead panels.

### BACKGROUND OF THE INVENTION

Floors and bulkheads define the interior of a commercial airliner. The flight deck, for instance, is defined generally by a floor and a bulkhead separating the flight crew from the main cabin and from the luggage storage area. Likewise, the main cabin of an airliner is separated from the flight deck and from the luggage compartment by a floor and one or more bulkheads.

Modern bulkheads comprise honeycomb panels generally of either aluminum or composite material faced on either side by metal or laminate sheets bonded to the honeycomb panel. Because of this construction, the modern bulkhead panel is light, rigid, and very resistant to deformation on impact. The virtue in this form of construction is the rigidity occasioned by the honeycomb panel fixedly maintaining the sheets in parallel relationship.

Conventional screws will not work well to affix hardware or fittings to a modern bulkhead panel. Because screws work by engaging the material surrounding the screw in the inclined threads spiraling around the shaft of the screw, the screws will not work where, as with a honeycomb panel, the volume is filled with defined hexagonal voids. These voids provide strength and resistance to deformation along their length but are very vulnerable to radial forces.

One solution has been used. At the time of forming the bulkhead, the honeycomb is interrupted with solid material at points pre-designated to receive hardware. This process is labor-intensive, time-consuming, and results in a bulkhead panel that is heavy and will not readily adapt to a more than one configuration. There is no opportunity for after-manufacture modifications to the panel if the modification requires setting hardware.

In order to optimize the strength of the bulkhead construction, a fastener would exploit the strength along the length of the hexagonal void and minimize the radial forces. There exists, then, an unmet need in the art to provide a fastener that will securely hold hardware fixedly to a modern bulkhead panel.

### SUMMARY OF THE INVENTION

The present invention is a flanged cylinder assembly. An exemplary embodiment of the invention includes a cylindrical housing having an axis and defining a bore along the axis. A spirally threaded groove is defined within the bore. The groove is spirally situated about the bore. The groove is arranged to engage a threaded land on a shaft of a fastener to secure the fastener in the bore. A flange is fixedly attached to the cylindrical housing perpendicular to the axis.

The present invention allows secure fixation of a load to a bulkhead. The sleeve is readily adaptable to existing threaded fasteners such as machinery screws and bolts. The invention provides threads to engage threaded fasteners allowing their use in modern bulkhead panels.

### BRIEF DESCRIPTION OF THE DRAWINGS

The preferred and alternative embodiments of the present invention are described in detail below with reference to the following drawings.

FIG. 1a is a cross-section view of fitting residing in a first bulkhead panel;

FIG. 1b is a cross-section view of fitting residing in a second bulkhead panel;

FIG. 2a is a perspective view of the invention;

FIG. 2b is a axial view of the invention; and

FIG. 2c is a radial view of the invention.

### DETAILED DESCRIPTION OF THE INVENTION

By way of overview, an exemplary embodiment of the invention is a flanged cylinder assembly. The assembly includes a cylindrical housing having an axis and defining a bore along the axis. A spirally threaded groove is defined within the bore. The groove is spirally situated about the bore. The groove is arranged to engage a threaded land on a shaft of a fastener to secure the fastener in the bore. A flange is fixedly attached to the cylindrical housing perpendicular to the axis.

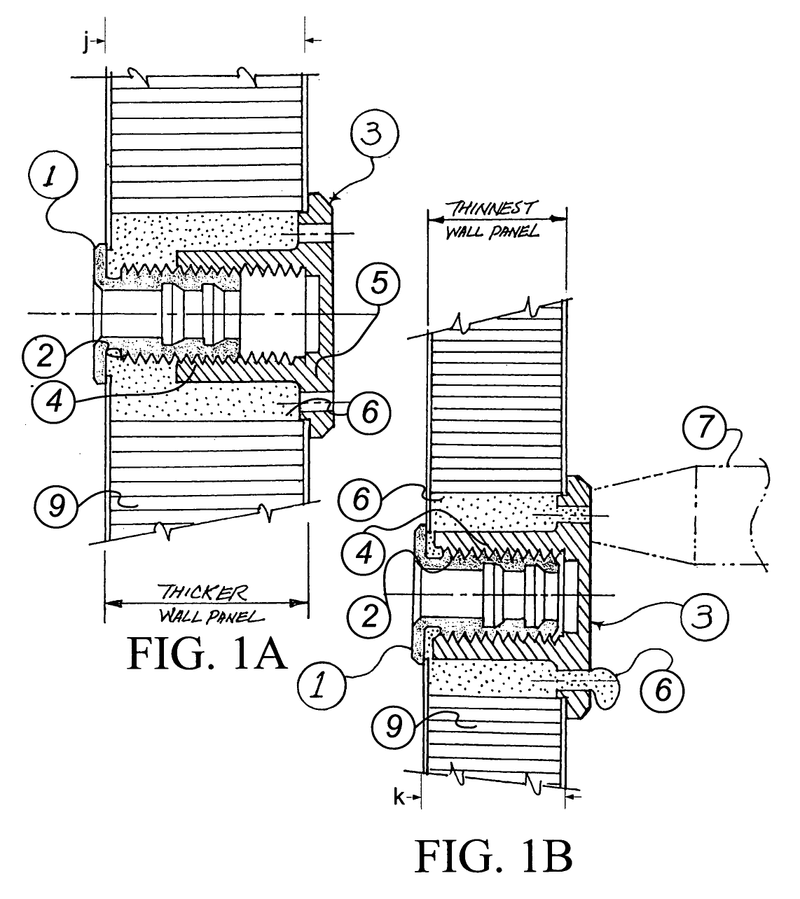

Referring to FIGS. 1a and 1b, there are presently two principle components of the securing system. In a bulkhead 9, a threaded fastener 1 (in the illustrated embodiment, the threaded fastener is a sleeve for receiving a pip pin suitably flanged and threaded along its outer surface) with external threads 2 engages a flanged cylinder assembly 3 including an internally threaded cylinder 4 and a flange 5. The flanged cylinder assembly 3 is then twisted and torqued such that the distance between the inner surfaces of the flanges approximates the width of the bulkhead. In FIG. 1a, the bulkhead 9 has a width of j, while in FIG. 1b, the bulkhead has a lesser width k. These FIGURES demonstrate the ability of the presently preferred embodiment to be configured to accommodate a range of suitable bulkhead widths.

The threaded fastener 1 and the flanged cylinder assembly 3 are potted in a suitable potting adhesive 6 injected into a void defined by drilling a hole of suitable diameter into the bulkhead 9 by a syringe 7. The potting adhesive 6 assists in filling the several hexagonal voids that the drilling of a hole interrupts. By filling the interrupted hexagonal voids, the potting adhesive 6 serves to fixedly hold the threaded fastener 1 and the flanged cylinder assembly 3 in the bulkhead 9.

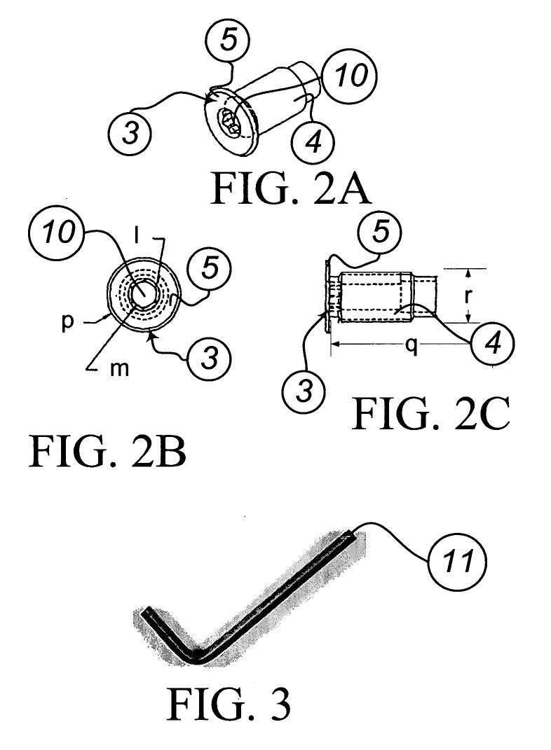

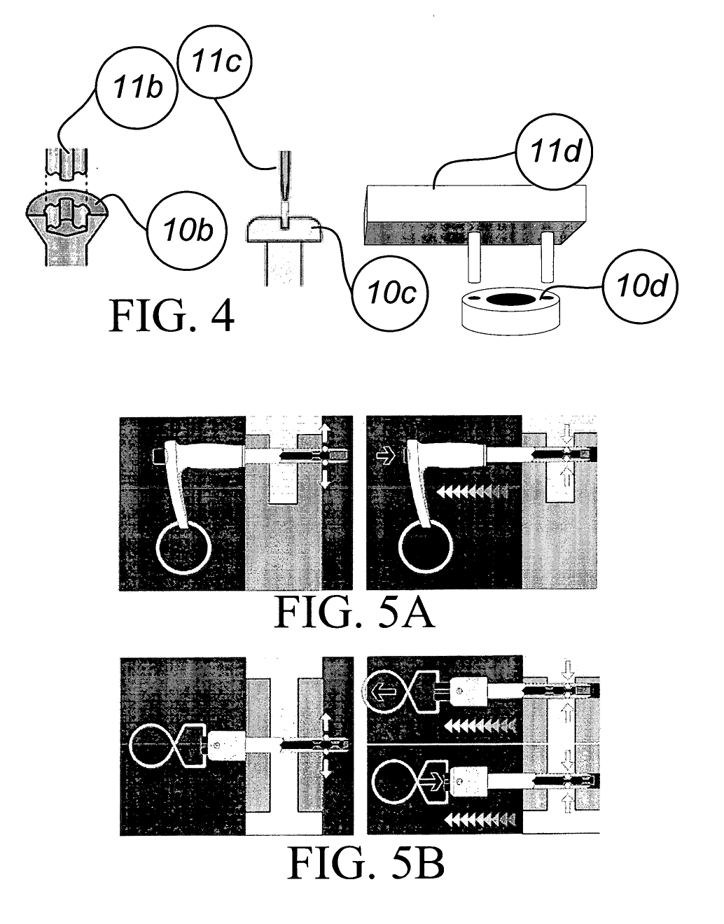

FIG. 2a is a perspective view of the invention. The flanged cylinder assembly 3 is shown to reveal the spatial relationship between the constituent flange 5 and the internally threaded cylinder 4.

FIG. 2b is a axial view of the invention. The flanged cylinder assembly 3 is shown only by the flange 5. The flange 5 defines a cavity with diameter 1. Within the cavity, in one presently preferred embodiment, the flange 5 further defines a hexagonal keyway with nominal measurement m. The keyway is used to impart torque to facilitate the threaded engagement with a threaded fastener 1. Those skilled in the art will readily appreciate that the threaded keyway may be configured to receive not only a hexagonal Allen-type wrench, but any of several male wrenches, such as Torx®. Alternatively, the flange 5 might be configured with two holes in opposing relationship configured to receive a spanner-type wrench for imparting torque or a straight slot suitably cut in the face of the flange would receive a flat blade like that of a screwdriver. The flange 5 has an outer diameter p.

FIG. 2c is a radial view of the flanged cylinder assembly 3 again illustrating the spatial relationship of the flange 5 to the internally threaded cylinder 4. The internally threaded cylinder 4 has a diameter r and a shoulder depth q suitably selected in accordance with dimensions of the hole bored into the bulkhead 9.

While the preferred embodiment of the invention has been illustrated and described, as noted above, many changes can be made without departing from the spirit and scope of the invention. Accordingly, the scope of the invention is not limited by the disclosure of the preferred embodiment.

What is claimed is:

1. A flanged cylinder assembly, the assembly comprising:
a cylindrical housing having an axis and defining a bore along the axis;
a spirally threaded groove being defined within the bore, the groove being spirally situated about the bore, the groove being arranged to engage a threaded land on a shaft of a fastener to secure the fastener in the bore; and
a flange fixedly attached to the cylindrical housing perpendicular to the axis.

2. The assembly of claim 1, wherein the flange defines a shaped cavity for receiving a wrench.

3. The assembly of claim 2, wherein the wrench is an Allen-type wrench and the shaped cavity defines a hexagon.

4. The assembly of claim 2, wherein the wrench is an Torx-type wrench and the shaped cavity defines a eight-pointed star.

5. The assembly of claim 1, wherein the flange is configured to receive a bladed tool and configured to receive torque about the axis.

6. The assembly of claim 1, wherein the flange is configured to receive a pin spanner tool and configured to receive torque about the axis.

7. The assembly of claim 1, wherein the flanged cylinder assembly is embedded in a bulkhead.

8. The assembly of claim 7, wherein the cylindrical housing is fixedly secured in the bulkhead by an adhesive.

9. The assembly of claim 1, wherein the fastener secures a load.

10. The assembly of claim 1, wherein the fastener is a pip pin.

11. A method for securing a pip pin to a sleeve, the method comprising:
providing a flanged cylinder assembly including a cylindrical housing haing an axis and defining a bore along the axis, a spirally threaded groove defined within the bore, the groove being spirally situated about the bore, the groove arranged to engage a threaded land on a shaft of a fastener to secure the fastener in the bore, and a flange fixedly attached to the cylindrical housing perpendicular to the axis;
inserting the flanged cylinder assembly into a cavity defined by a bulkhead, the cavity having a first end and a second end corresponding to first surface and a second surface of the bulkhead, the flanged cylinder assembly being inserted into the first end of the cavity;
inserting the threaded fastener into the second end of cavity; and
rotating the flanged cylinder assembly relative to the threaded fastener in order to threadedly engage the flanged cylinder assembly.

12. The method of claim 11, further comprising embedding the flanged cylinder assembly into the cavity.

13. The method of claim 12, wherein embedding the flanged cylinder assembly into the bulkhead includes inserting potting adhesive into the cavity.

14. The method of claim 13, wherein the potting adhesive fixedly bolds the flanged cylinder assembly in the cavity.

15. The method of claim 11, wherein the fastener secures a load.

16. The method of claim 11, wherein the fastener is a pip pin.

17. A fitting for securing a bracket with a fastener, the fitting comprising:
a flanged cylinder assembly, the assembly comprising:
a cylindrical housing having an axis, and defining a bore along the axis; and
a spirally threaded groove being defined within the bore, the groove being spirally situated about the bore, the groove being arranged to engage a threaded land on a shaft of a fastener to secure the threaded fastener in the bore;
a flange fixedly attached to the cylindrical housing perpendicular to the axis; and
a bracket defining an aperture to receive the threaded fastener therein, the bracket being inserted between the threaded and the flanged cylinder assembly such that the bracket is secured to the flanged cylinder assembly by insertion of the fastener therethrough.

18. The fitting of claim 16, wherein the bracket supports a load.

19. The fitting of claim 16, wherein the threaded fastener is a pip pin.

20. The fitting of claim 16, wherein the flanged cylinder assembly is embedded in a bulkhead.

21. The fitting of claim 19, wherein the flanged cylinder assembly is fixedly embedded in a bulkhead.

22. The fitting of claim 20, wherein the flanged cylinder is fixedly embedded by a potting adhesive.
